(19) United States
(12) Patent Application Publication
(10) Pub. No.: US 2025/0178632 A1
(43) Pub. Date: Jun. 5, 2025

(54) INFORMATION NOTIFICATION SYSTEM, VEHICLE CONTROL DEVICE, PROGRAM, AND INFORMATION NOTIFICATION METHOD

(71) Applicant: DENSO CORPORATION, Kariya-City (JP)

(72) Inventors: Hideyuki HONYA, Kariya-City (JP); Satoshi NIWA, Kariya-City (JP); Kei OKADA, Kariya-City (JP); Hiroshi HIRASHIMA, Kariya-City (JP)

(21) Appl. No.: 19/050,927

(22) Filed: Feb. 11, 2025

Related U.S. Application Data
(63) Continuation of application No. PCT/JP2023/029155, filed on Aug. 9, 2023.

(30) Foreign Application Priority Data
Aug. 15, 2022 (JP) 2022-129307

(51) Int. Cl. B60W 50/14; B60W 30/182; B60W 40/08

(52) U.S. Cl. CPC B60W 50/14; B60W 30/182; B60W 40/08; B60W 2050/143; B60W 2050/146; B60W 2520/10; B60W 2540/227; B60W 2554/406; B60W 2555/20

(57) ABSTRACT

An information notification system, a vehicle control device, an information notification method, or a non-transitory computer-readable storage medium storing a program determines notifiable information indicating a situation required for notifying an occupant of application information, provides the notifiable information to an application, and notifies the occupant of the application information based on the notifiable information.

### CROSS REFERENCE TO RELATED APPLICATIONS

The present application is a continuation application of International Patent Application No. PCT/JP2023/029155 filed on Aug. 9, 2023, which designated the U.S. and claims the benefit of priority from Japanese Patent Application No. 2022-129307 filed on Aug. 15, 2022. The entire disclosures of all of the above applications are incorporated herein by reference.

### TECHNICAL FIELD

The present disclosure relates to a technology for notifying an occupant in a vehicle of information.

### BACKGROUND

Conventionally, there is known technology for providing (i.e., notifying) various types of information to occupants of a vehicle (for example, an automobile) via terminal devices such as an in-vehicle display or speaker.

A comparative technology involves a vehicle communicating with a center device via a network, and notifying the occupant of information provided to the vehicle from the center device via an in-vehicle terminal device.

### SUMMARY

An information notification system, a vehicle control device, an information notification method, or a non-transitory computer-readable storage medium storing a program determines notifiable information indicating a situation required for notifying an occupant of application information, provides the notifiable information to an application, and notifies the occupant of the application information based on the notifiable information.

### BRIEF DESCRIPTION OF THE DRAWINGS

FIG. 1 is an explanatory diagram showing an overall configuration of an information notification system according to a first embodiment.

FIG. 2 is an explanatory diagram showing a main part of the configuration of an in-vehicle device and the like in the first embodiment.

FIG. 3 is an explanatory diagram showing an electrical configuration of an in-vehicle device according to the first embodiment.

FIG. 4 is a block diagram functionally showing a vehicle control unit, a vehicle application unit, and a server application unit in the first embodiment.

FIG. 5 is a flowchart showing a control process of the information notification system according to the first embodiment.

### DETAILED DESCRIPTION

As a result of detailed study by the inventor, the following difficulties have been found in the conventional technology.

A vehicle may be in various stop states, such as waiting at a traffic light or when parking. Under such situations, it may be possible to notify the occupants of various types of information, such as necessary safety information and advertisement information.

For example, when considering a case where advertisements are provided to occupants with different times at which notification of information is provided to the occupants (for example, advertisement playback times), since the vehicle's stopping time differs depending on the vehicle state (for example, stop state), there is a risk that the advertisement cannot be played in its entirety during the stopping time.

For example, in the case where the advertisement is being played while the vehicle is waiting at a red light, the advertisement may be cut off midway through playback when the light turns green and the vehicle switches to driving mode. For example, a screen displaying an advertisement or audio of the advertisement may be interrupted and switched to a screen or audio of route guidance required for driving.

According to one example of the present disclosure, it is desirable to provide a technology that can appropriately notify the vehicle occupant of information at an appropriate time.

(1) According to one aspect of the present disclosure, in an information notification system, one or more applications are provided in at least one of a vehicle or a cloud, and notification of application information that is information provided by the one or more applications is provided from the vehicle to an occupant.

In this information notification system, the vehicle includes an information decision unit and an information provision unit as a vehicle control unit that controls the operation of the vehicle.

The information decision unit is configured to determine notifiable information indicating the conditions necessary for notifying an occupant of application information based on a vehicle-related situation indicating at least one of a vehicle traveling situation indicating the vehicle's traveling situation, a vehicle exterior situation indicating the situation in the periphery of the vehicle, and a vehicle interior situation indicating the situation inside the vehicle.

The information provision unit is configured to provide the notifiable information determined by the information decision unit to the application.

Furthermore, the application is configured to request the vehicle control unit to notify the occupant of the application information based on the notifiable information provided by the information providing unit.

According to this configuration of the present disclosure, it is possible to notify the vehicle occupant of information (i.e., application information) appropriately at an appropriate time.

Specifically, in the present disclosure, the vehicle control unit provides the application with notifiable information (for example, a time when a notification is possible, a notification type, a mode of notification, etc.) determined based on the vehicle traveling situation, the vehicle exterior situation, and the vehicle interior situation. Therefore, the application can notify the occupant of the application information through the vehicle control unit based on the notifiable information.

In other words, in the present disclosure, the application notifies the occupant of the application information to the vehicle control unit based on the notifiable information. Therefore, the vehicle control unit can notify the occupant of the application information appropriately at an appropriate time (for example, with a notification method or content that makes it easy for the occupant to understand the notification content).

(2) According to another example of the present disclosure, a vehicle control unit notifies an occupant of application information that is information provided from a vehicle to the occupant based on a request from one or more applications provided in at least one of the vehicle or a cloud.

This vehicle control device includes an information decision unit, an information provision unit, and an occupant provision unit.

The information decision unit is configured to determine notifiable information indicating the conditions necessary for notifying an occupant of application information based on a vehicle-related situation indicating at least one of a vehicle traveling situation indicating the vehicle's traveling situation, a vehicle exterior situation indicating the situation around the vehicle, and a vehicle interior situation indicating the situation inside the vehicle.

The information provision unit is configured to provide the notifiable information determined by the information decision unit to the application.

The occupant provision unit is configured to instruct a notification device to provide the application information to the occupant using the application information when the application requests that notification of the application information is provided to the occupant based on the notifiable information provided by the information provision unit.

According to this configuration of the present disclosure, it is possible to notify the vehicle occupant of information (i.e., application information) appropriately at an appropriate time.

In other words, in the present disclosure, when an application requests to notify the occupant of the application information based on the notifiable information provided by the information provision unit, the notification device is instructed to provide the occupant with the application information. Therefore, the vehicle control device can notify the occupant of the application information appropriately at an appropriate time (for example, with a notification method or content that makes it easy for the occupant to understand the notification content).

(3) According to another example of the present disclosure, a program is executed by an information notification system in which one or more applications are provided in at least one of a vehicle or a cloud, and notification of application information that is information provided by the one or more applications is provided from the vehicle to an occupant.

This program determines notifiable information indicating a situation required for notifying the occupant of the application information based on a vehicle-related situation indicating at least one of a vehicle traveling situation indicating a traveling situation of the vehicle, a vehicle exterior situation indicating a situation in a periphery of the vehicle, or a vehicle interior situation indicating a situation inside the vehicle, provides the determined notifiable information to the application; and causes the application to request a vehicle control unit that controls an operation of the vehicle to notify the occupant of the application information based on the provided notifiable information.

According to this configuration of the present disclosure, it is possible to notify the vehicle occupant of information (i.e., application information) appropriately at an appropriate time.

(4) According to another example of the present disclosure, in an information notification method, one or more applications are provided in at least one of a vehicle or a cloud, and notification of application information that is information provided by the one or more applications is provided from the vehicle to an occupant.

This information notification method determines notifiable information indicating a situation required for notifying the occupant of the application information based on a vehicle-related situation indicating at least one of a vehicle traveling situation indicating a traveling situation of the vehicle, a vehicle exterior situation indicating a situation in a periphery of the vehicle, or a vehicle interior situation indicating a situation inside the vehicle, provides the determined notifiable information to the application; and causes the application to request a vehicle control unit that controls an operation of the vehicle to notify the occupant of the application information based on the provided notifiable information.

According to this configuration of the present disclosure, it is possible to notify the vehicle occupant of information (i.e., application information) appropriately at an appropriate time.

Furthermore, the numerals parentheses in this column and in the claims indicate the correspondence with the specific means described in the embodiment described later as one aspect, and do not limit the technical scope of the present disclosure.

Hereinafter, exemplary embodiments of the present disclosure will be described with reference to the drawings.

### 1. First Embodiment

In the first embodiment, an information notification system applied to a vehicle (for example, an automobile) will be described.

### 1-1. Overall Configuration

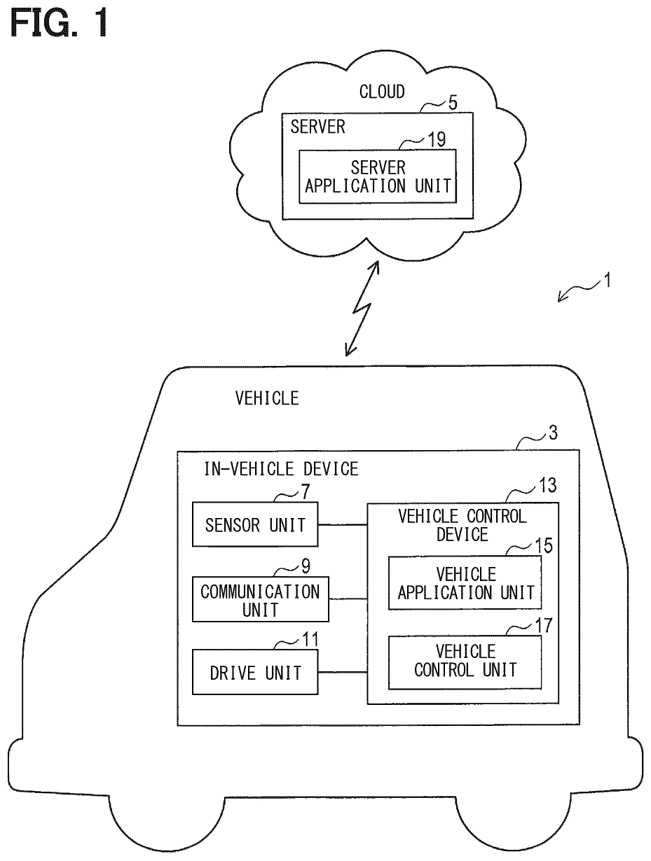

As shown in FIG. 1, in the first embodiment, an information notification system 1 includes an in-vehicle device 3 as a vehicle configuration, and a server 5 as a cloud configuration. It should be noted that this information notification system 1 is an example of a mobility IoT system, where IoT is an abbreviation for Internet of Things.

The in-vehicle device 3 includes a sensor unit 7, a communication unit 9, an actuator 11, and a vehicle control device 13, and the vehicle control device 13 is connected to the sensor unit 7, the communication unit 9, and the actuator 11.

Among these, the sensor unit 7 may include a device that detects the traveling situations of a vehicle (i.e., subject vehicle), a device that detects the situations inside the vehicle (i.e., the interior where the occupants sit), a device that detects the situations in the periphery of the vehicle, and the like.

Examples of devices that detect the traveling situations of a vehicle (i.e., the vehicle traveling situation) include a vehicle speed sensor that detects the speed of the vehicle, an acceleration sensor that detects the acceleration of the vehicle, a steering sensor that detects the steering angle, a gear position sensor that detects the gear state, a GPS device that detects the current position of the vehicle, and the like.

Devices for detecting the interior situation of a vehicle (i.e., the vehicle interior situation) include a camera for capturing the interior, a seating sensor for detecting the seating state of an occupant, and a temperature sensor for detecting the temperature inside the vehicle.

Devices for detecting the situation in the periphery of the vehicle (i.e., the situation outside the vehicle) include radar devices, lidar devices, sonar, cameras that capture images of the periphery of the vehicle, and the like. As described later, the situation in the periphery of the vehicle may be detected based on information from an external device such as the cloud.

The communication unit 9 is a communication device used to communicate with devices outside the vehicle (for example, the cloud server 5).

The actuator 11 is an actuator used to notify the occupant of information (for example, application information).

The vehicle control device 13 is a device that controls the operation of the vehicle, and includes a vehicle application unit 15 and a vehicle control unit 17, as described later.

On the other hand, the server 5 includes a server application unit 19 as described later.

### 1-2. Configurations of Information Notification System

Next, each configuration of the information notification system 1 will be described in more detail.

### Vehicle Configuration

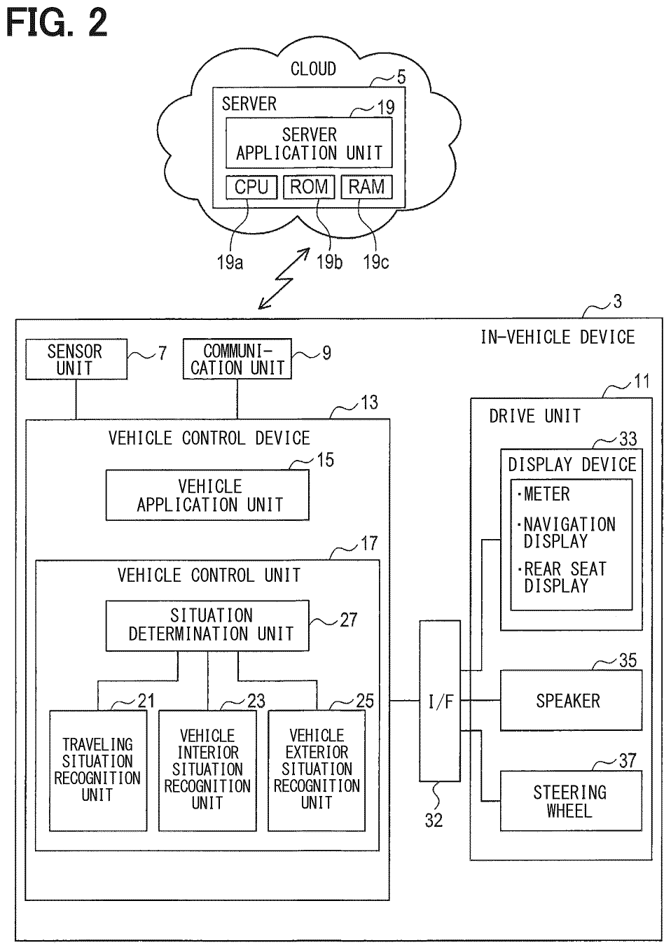

As shown in FIG. 2, the vehicle control device 13 includes the vehicle application unit 15 that controls the operation of a vehicle application (hereinafter, vehicle app), which is application software (hereinafter, application) installed in the vehicle, and the vehicle control unit 17 that controls the operation of the vehicle.

The vehicle application unit 15 and the vehicle control unit 17 can each be implemented using a well-known CPU and memory such as ROM or RAM. However, here, a case where the vehicle application unit 15 and the vehicle control unit 17 are implemented using the same CPU and memory will be described as an example.

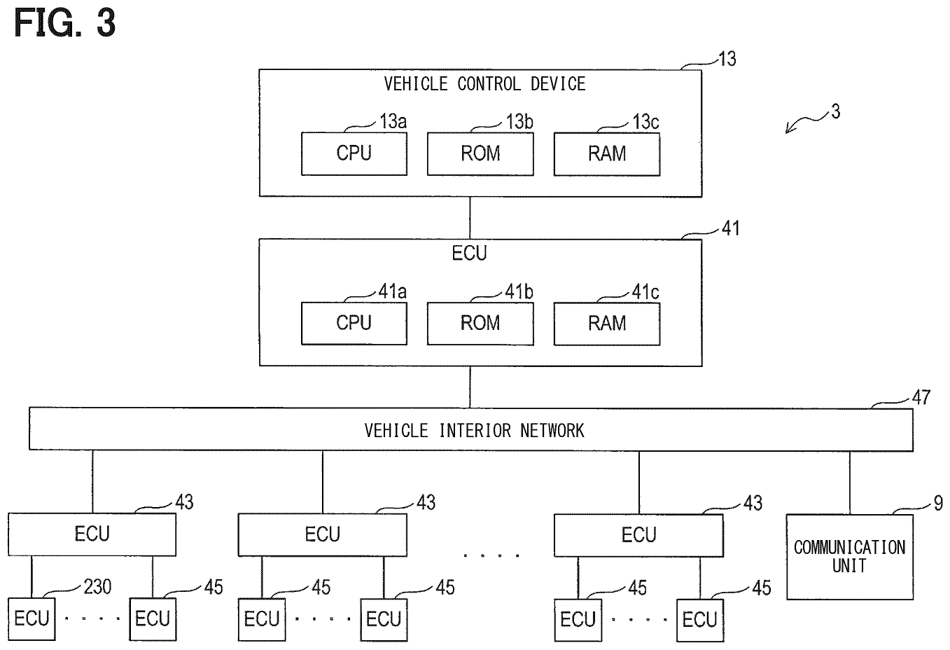

As described above, the vehicle control device 13 is an electronic control unit (that is, ECU) including a memory such as a CPU 13a, a ROM 13b, and a RAM 13c (see FIG. 3). The ECU is an abbreviation for Electronic Control Unit. In other words, the vehicle control device 13 is a device equipped with a well-known microcomputer (not shown). The memory is not limited to a memory within a microcomputer, but may be any of various storage devices outside a microcomputer (for example, a hard disk).

Various functions executed by the ECU are implemented by the CPU 13a executing programs stored in a non-transitory tangible storage medium. In this example, the memory corresponds to a non-transitory tangible storage medium for storing a program. Further, by executing this program, a method corresponding to the program is executed.

In addition, the memory stores not only various programs (for example, programs for controlling the operation of the vehicle and programs for implementing the applications described above) but also various data used when executing the various programs. For example, information such as warnings (i.e., alerts) and advertisements to be provided to the occupants described later is stored.

The method of implementing the various functions of the ECU is not limited to software, and some or all of the elements may be implemented using one or more pieces of hardware. For example, in a case where the above-described functions are implemented by an electronic circuit that is hardware, the electronic circuit may be implemented by a digital circuit including a large number of logic circuits, an analog circuit, or a combination thereof.

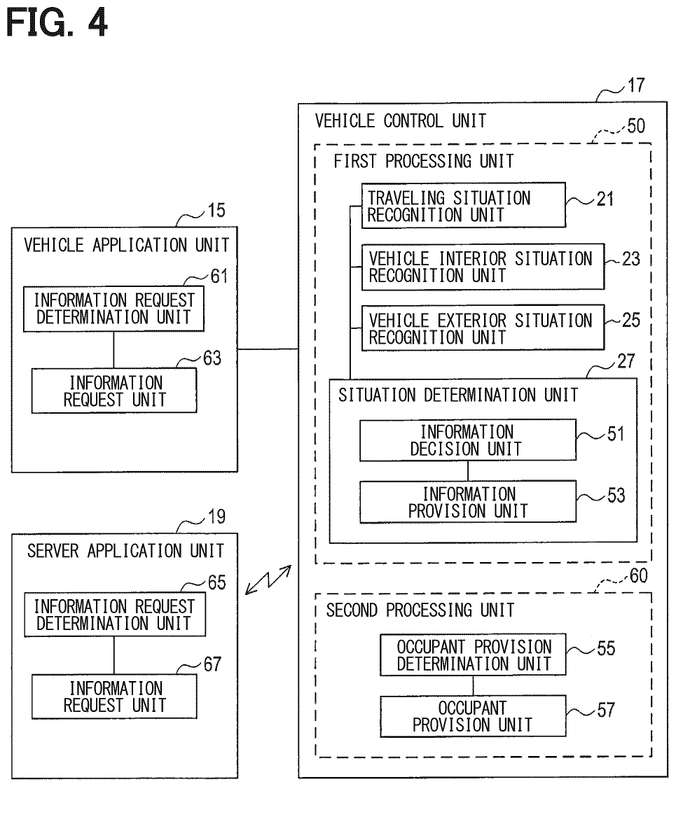

The vehicle control unit 17 described above functionally includes a traveling situation recognition unit 21, a vehicle interior situation recognition unit 23, a vehicle exterior situation recognition unit 25, and a situation determination unit 27. These configurations and other functional configurations will be described in detail later with reference to FIG. 4.

As described above, the in-vehicle device 3 also includes various actuators serving as the actuator 11 in order to provide (i.e., notify) the occupant of various information (for example, application information). In the following, the actuator 11 will be referred to as an actuator.

Examples of the actuator 11 include a display device 33 such as a meter, a navigation display, or a rear seat display, a speaker 35, a steering wheel 37 equipped with a vibration device (not shown), and the like. Each actuator 11 is connected to the vehicle control device 13 via an interface (i.e., I/F) 32.

### Overall Hardware Configuration of In-vehicle Device

Here, an example of the overall hardware configuration of the in-vehicle device will be described. These configurations are known and will be described briefly below.

As shown in FIG. 3, the vehicle is equipped with the vehicle control device 13, another ECU 41, multiple ECUs 43, multiple ECUs 45, the communication unit 9 which is a vehicle exterior communication device, and a vehicle interior communication network 47.

The ECU 41 controls the multiple ECUs 43 to achieve coordinated control of the entire vehicle.

The ECU 41 is placed for each domain divided by function in the vehicle, and mainly controls multiple ECUs 45 existing within that domain. Each ECU 43 is connected to a subordinate ECU 45 via a lower layer network that is individually placed for each ECU 43. The ECU 43 has a function of centrally managing access privilege of the ECU 45 under the control thereof and authenticating users. The domains are, for example, a powertrain domain, a body domain, a chassis domain, and a cockpit domain.

The ECUs 45 connected to the ECU 43 belonging to the powertrain domain include, for example, an ECU 45 that controls an engine, an ECU 45 that controls a motor, and an ECU 45 that controls the battery.

The ECUs 45 connected to the ECU 43 belonging to the body domain include, for example, an ECU 45 that controls an air conditioner, and an ECU 45 that controls a door.

The ECUs 45 connected to the ECU 43 belonging to the chassis domain include, for example, an ECU 45 that controls braking, and an ECU 45 that controls the steering wheel 37.

The ECUs 45 connected to the ECU 43 belonging to the cockpit domain include, for example, an ECU 45 that controls the display of the display device 33 such as meters and various displays, an ECU 45 that controls the operation of the speaker 35, and an ECU 45 that controls input devices operated by the vehicle occupant.

The communication unit 9 executes data communication with a communication device outside the vehicle (for example, a cloud server 5) via the wide area wireless communication network NW.

The vehicle interior communication network 47 includes CAN FD and Ethernet (registered trademark). The CAN FD is an abbreviation for CAN with Flexible Data Rate. The CAN FD connects the ECU 41 to each ECU 43 and the communication unit 9 via a bus. The Ethernet individually connects the ECU 41 to each of the ECUs 43 and the communication unit 9.

The ECU 41, like the vehicle control device 13, is an electronic control unit mainly including a microcomputer including a CPU 41a, a ROM 41b, a RAM 41c, and the like. The ECUs 43 and 45 have the same configuration.

The ECU 41 is connected to the vehicle control device 13 so as to perform data communication with the vehicle control device 13. That is, the vehicle control device 13 receives information from the ECU 43 and the ECU 45 via the ECU 41. In addition, the vehicle control device 13 transmits requests related to vehicle control, and the like to the ECU 41, and transmits the requests to the ECU 43 and the ECU 45 via the ECU 41.

### Server Configuration

As shown in FIG. 2, the cloud server 5 includes the server application unit 19 that controls the operation of applications installed on the server 5 (hereinafter, server applications).

Similarly to the vehicle application unit 15, the server application unit 19 can be implemented by a known CPU 19a, memories such as a ROM 19b, and a RAM 19c, and the like.

In addition, when there are multiple vehicles, the server 5 configured as described above can collect vehicle data transmitted via the communication unit 9 from each of the vehicle control devices 13 of each vehicle. Furthermore, the server 5 can store the collected data for each vehicle in a storage (not shown). In addition, the server 5 can create a digital twin based on the vehicle data stored in the memory. The digital twin is normalized index data.

### 1-3. Functional Configuration of Information Notification System

Next, functions and configurations of the information notification system 1 will be described.

### Vehicle Configuration

As shown in FIG. 4, the vehicle control unit 17 functionally includes a first processing unit 50 and a second processing unit 60.

The first processing unit 50 is a processing unit that performs processing to provide notifiable information to an application based on the vehicle traveling situation and the situations inside and outside the vehicle.

The first processing unit 50 described above functionally includes the traveling situation recognition unit 21, the vehicle interior situation recognition unit 23, the vehicle exterior situation recognition unit 25, and the situation determination unit 27. Moreover, the situation determination unit 27 functionally includes an information decision unit 51 and an information provision unit 53.

On the other hand, the second processing unit 60 is a processing unit that performs processing when there is a request (i.e., a notification request) from an application to notify an occupant of information (i.e., application information, which is information provided by the application). The second processing unit 60 functionally includes an occupant provision determination unit 55 and an occupant provision unit 57.

Hereinafter, a specific description will be given.

### Function of First Processing Unit

The traveling situation recognition unit 21 is configured to recognize the traveling situation of the vehicle based on information from the sensor unit 7 that detects the traveling situation of the vehicle. Examples of the vehicle traveling situations include stopped, traveling, traveling at a high speed equal to or higher than a predetermined value, traveling at a low speed lower than a predetermined value, and the like. Examples of the state where the vehicle being stopped include stopping due to traffic regulations, such as at a traffic light, a railroad crossing, an intersection, or a pedestrian crossing, as well as other stopping times.

The vehicle interior situation recognition unit 23 is configured to recognize the situation inside the vehicle based on information from the sensor unit 7 that detects the situation inside the vehicle (i.e., the vehicle interior situation). Examples of the vehicle interior situations include the number of occupants, the seating positions of the occupants, the use of the actuator 11 that provides information to the occupants, the temperature inside the vehicle, and the operating status of the air conditioner.

The vehicle exterior situation recognition unit 25 is configured to recognize the situation in the periphery of the vehicle based on information from the sensor unit 7 that detects the situation in the periphery of the vehicle (i.e., the situation outside the vehicle) and information obtained from the cloud. Examples of situations in the periphery of the vehicle (i.e., subject vehicle) include the traveling situations of other vehicles in the periphery of the subject vehicle, the type of traveling road (for example, whether it is an expressway or a general road), the situations of the traveling road (for example, whether there is traffic congestion), the situations of roadside objects and other structures in the periphery of the road (for example, the presence of traffic lights and various road signs), peripheral weather situations, and peripheral brightness.

The situation determination unit 27 determines the situation in which the vehicle is located based on information from the traveling situation recognition unit 21, the vehicle interior situation recognition unit 23, and the vehicle exterior situation recognition unit 25, i.e., based on the situation of the vehicle itself and the situations inside and outside the vehicle.

The situation determination unit 27 performs the following processes of the information decision unit 51 and the information provision unit 53 based on the situation in which the vehicle is located.

The information decision unit 51 is configured to determine notifiable information indicating the conditions necessary for notification of various application information such as safety information and infotainment information to occupants based on vehicle-related situations indicating at least one of the vehicle traveling situation, the vehicle exterior situation, or the vehicle interior situation.

The notifiable information (i.e., information provided from the vehicle control unit 17 to the application) indicating the conditions necessary for notifying the occupant of the application information is information that serves as the basis for the application to determine whether to notify the occupant of the application information and how to provide the application information.

The notifiable information may include, for example, at least one of a notifiable time, a notification type, or a notification mode according to a situation.

The notifiable time is the time during which the notification of the application information can be provided to the occupant. In other words, this is the time during which the actuator 11 can be driven to notify the occupant of the application information, in other words, the free time during which the actuator 11 is not driven or the free time during which there are no schedules to drive the actuator 11. The time may be, for example, a time from a certain time to a certain time.

The notifiable time can be determined from the current usage state of the actuator 11 and the schedule for using the actuator 11.

The notification type is the type of device (i.e., the actuator 11) that notifies the occupant of the application information. In other words, the notification type is the method of notification (i.e., the means of notification). Examples of notification means include visual devices such as a meter, a head-up display, and a center display, audio devices such as a speaker, and tactile devices such as a steering wheel.

The notification mode according to the situation is information indicating desirable state for notifying the occupant depending on the situation. Examples of the notification mode according to the situation include, for example, when an occupant (for example, the driver) is busy driving the vehicle (i.e., in the busy case), information indicating that the occupant is busy, and information indicating a state appropriate for the busy situation (for example, notification of only application information for a short period).

In addition, examples of notification modes according to the situation include modes corresponding to at least one of the following situations: the vehicle's traveling situations, the situations inside the vehicle (for example, the situations of the occupants), and the situations in the periphery of the vehicle (i.e., the outside), as described later.

For example, when the vehicle control unit 17 provides, to an application, information indicating that the application is busy (i.e., a notification mode appropriate to the situation), the application can provide, to the vehicle control unit 17 (and therefore the occupants), application information (for example, only application information for a short period) that corresponds to the busy state (i.e., in an information provision state appropriate to the busy state).

For example, in the busy state, it is considered that compact notification of the contents of the application information (for example, notification of only a portion of the information) is provided, or notification of application information that is less urgent (i.e., less important) is not provided.

Therefore, when the vehicle control unit 17 provides, to an application, the notification mode appropriate to the situation, the application can notify the vehicle control unit 17 of application information in an appropriate state (for example, appropriate method or content) depending on the notification mode. Alternatively, it is possible to prevent the notification of the application information, or to wait until a situation suitable for the notification mode occurs before the notification of the application information.

The information provision unit 53 is configured to provide the notifiable information determined by the information decision unit 51 to the server 5 or an application installed in the vehicle (i.e., a server application or vehicle application), for example, periodically.

### Function of Second Processing Unit

The occupant provision determination unit 55 is configured to determine whether it is actually possible to notify (i.e., provide) the application information at this time when there is a request (i.e., a notification request) from an application to notify the occupant of the application information. In other words, the occupant provision determination unit 55 can confirm whether there is actually time to provide the application information to the occupant at this time, and whether the actuator 11 can be driven to provide the application information to the occupant.

In addition, the occupant provision determination unit 55 is configured to receive information indicating the recognition result of the traveling situation by the traveling situation recognition unit 21, the recognition result of the vehicle interior situation (for example, the situation of the occupants) by the vehicle interior situation recognition unit 23, and the recognition result of the vehicle exterior situation by the vehicle exterior situation recognition unit 25. Accordingly, for example, when a notification request is received, the occupant provision determination unit 55 can adjust the state of the content of the provided application information (i.e., adjust the state of notification) in accordance with each of the recognition results described above, and provide it to the occupant.

In addition, it may also be determined whether it is appropriate or possible to provide notification of the application information now. For example, in a case where a warning or other notification regarding driving safety is currently being given, when there is a request for notification of the advertisement, it can be determined that notification of the advertisement is not appropriate at this time.

Furthermore, the occupant provision determination unit 55 has an adjustment function (i.e., arbitration function) for determining which application should be given priority for execution when notification requests are received from multiple applications.

The occupant provision unit 57 is configured to drive the actuator 11 to provide the application information provided from the application to the occupant.

Here, the application information provided by the application is transmitted based on, for example, a vehicle-related situation and the notifiable information. For example, when the vehicle is parked for a long period and there is a sufficient time for notification of the application information (for example, when the vehicle is not busy), notification of the application information such as an advertisement may be performed for a prescribed sufficient period. On the other hand, for example, when traveling on the expressway at night and there is not enough time to perform the notification of the application information (for example, when it is busy), the content of the application information may be set compactly and the notification of the application information may be performed.

### Function of Vehicle Application Unit

In addition to the above-described vehicle control unit 17, the vehicle application unit 15, which is a component for the vehicle, functionally includes an information request determination unit 61 and an information request unit 63.

The information request determination unit 61 is configured to determine, when the notifiable information is provided from the information provision unit 53 to the vehicle application unit 15, whether it is appropriate to request the vehicle control unit 17 to notify the occupant of the application information based on the notifiable information.

For example, when notification of certain application information is performed by the vehicle app, the vehicle control unit 17 determines, based on information such as the available notification time and the notification type, whether there is time to provide the application information and whether the actuator 11 providing the application information can be driven. Then, based on the result of the determination, it is determined whether to make the notification request.

For example, when there is a time to provide the application information and the actuator 11 is operable, the notification request is made, when not, the notification request is not made.

The information request unit 63 is configured to request the vehicle control unit 17 to notify the occupant of the application information provided from the vehicle application based on the notifiable information provided by the information provision unit 53.

In other words, when it is determined based on the result of the determination by the information request determination unit 61 that it is appropriate (for example, possible) to provide the notification request, the information request unit 63 can provide the notification request to the vehicle control unit 17.

### Server Configuration

On the other hand, on the server 5, the server application unit 19 functionally includes an information request determination unit 65 and an information request unit 67, similar to the vehicle application unit 15.

Similarly to the information request determination unit 61 of the vehicle application unit 15, the information request determination unit 65 is configured to determine, when the notifiable information is provided from the information provision unit 53 to the server 5, whether it is appropriate to request the vehicle control unit 17 to notify the occupant of the application information based on the notifiable information.

Similarly to the information request unit 63 of the vehicle application unit 15, the information request unit 67 is configured to request the vehicle control unit 17 to notify the occupant of the application information provided from the application of the server 5 based on the notifiable information provided by the information provision unit 53.

### 1-4. Control Process

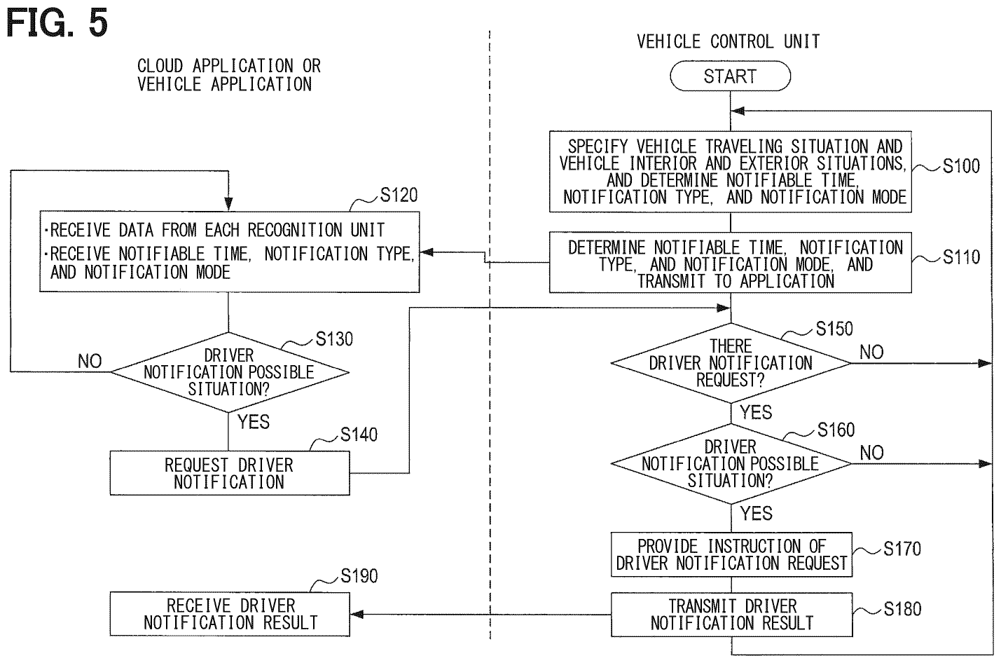

Next, a control process executed by the information notification system 1 will be described with reference to FIG. 5.

The control processing executed by the information notification system 1 includes a control process executed by the server and a control process executed by the vehicle.

The following process is executed, for example, when the ignition switch of the vehicle is turned on.

In step (hereinafter, S) 100 of the flowchart in FIG. 5, first, the vehicle control unit 17 of the vehicle control device 13 grasps the vehicle traveling situation, the vehicle interior situation, and the vehicle exterior situation using data from the traveling situation recognition unit 21, the vehicle interior situation recognition unit 23, and the vehicle exterior situation recognition unit 25. Then, based on the grasped situation, the notification mode (i.e., the mode of the notification) is determined according to, as the notifiable information, the notifiable time, the notification type, and the situation. At least one of the notifiable time, the notification type, or the notification mode may be determined.

In the next S110, the notifiable time, the notification type, and the notification mode are transmitted to the application (i.e., the server application or vehicle application). That is, the notifiable time, the notification type, and the notification mode are transmitted to the server application unit 19 and the vehicle application unit 15.

In addition to this, each application may use the information acquired by each recognition unit 21, 23, 25, so information corresponding to each situation acquired by each recognition unit 21, 23, 25 (for example, information on the vehicle speed, and the like) is transmitted to the server application unit 19 and the vehicle application unit 15.

The information according to each of the above-described situations may be transmitted to the server application unit 19 or the vehicle application unit 15 at a timing separate from the transmission of the notifiable time, the notification type, and the notification mode, for example, periodically.

In S120, the server application unit 19 and the vehicle application unit 15 (that is, on the application side) receive the information transmitted from each of the recognition units 21, 23, and 25. Also, the notifiable time, the notification type, and the notification mode are received.

In the next S130, the application determines whether it is possible to notify the occupant (for example, the driver) of the application information based on the received notifiable time, notification type, and notification mode. For example, when the actuator 11 is driven to provide the notification of the application information, it is determined whether the situation is such that the actuator 11 can be driven (for example, the actuator 11 is not being used to provide other information with a higher priority) and whether there is sufficient time to drive the actuator 11 to provide the notification of the entire application information. When the determination here is positive, the process proceeds to S140, whereas when the determination here is negative, the process returns to S120.

For example, when the display device 33 displays information regarding safety, it can be determined that the display device 33 is in a situation where it cannot display an advertisement that has a lower priority than safety (i.e., it is in a situation where it cannot provide a notification).

The application information of which notification is provided after the determination that notification is possible is set by the application based on the vehicle-related information or the notifiable information. That is, application information having contents suitable for the current situation is set by the application, so that when the notification of the application information is later provided to the occupant, the notification of the application information set here is provided.

In S140, the vehicle control unit 17 is requested to notify the occupant of application information such as advertisements. In addition, when the notification is requested, the application information to be notified is also transmitted to the vehicle control unit 17.

The application information for notification is, for example, set in advance by an application (i.e., prepared), but the content of the application information that is the notification target to the occupant may be changed depending on, for example, the notification mode. For example, when the occupant is busy, the content of the application information that is the notification target may be changed so that the application information is made compact and only the essential parts of the application information are provided.

In S150, the vehicle control unit 17 determines whether there has been a request from the server application unit 19 or the vehicle application unit 15 to notify the occupant of application information such as advertisements. When the determination here is positive, the process proceeds to S160, whereas when the determination here is negative, the process returns to S100.

In S160, the vehicle control unit 17 again determines whether it is possible to notify the occupant of the application information, similarly to S140. That is, here, in consideration of the actual current situation (for example, the vehicle speed, etc.), it is determined whether to provide the notification again. That is, the final determination is made as to whether to provide the notification of the application information. When the determination here is positive, the process proceeds to S170, whereas when the determination here is negative, the process returns to S100.

In S170, the vehicle control unit 17 executes a process for notifying the occupant of the application information. For example, the actuator 11 of the display device 33 or the like is driven to notify the occupant of application information such as advertisements. In other words, the notification of the application information appropriate for the current situation is provided based on the vehicle-related information and notifiable information.

In the next S180, the vehicle control unit 17 transmits, to the server application unit 19 and the vehicle application unit 15, a result that the notification of application information has actually been provided to the occupant. When the negative determination is made in S160 and the application information has not been notified, the server application unit 19 and the vehicle application unit 15 may be notified of the result that the notification of the application information has not been provided.

In S190, the server application unit 19 and the vehicle application unit 15 receive, from the vehicle control unit 17, the result that the application information has been notified to the occupant, and temporarily end this process.

### 1-5. Effects

According to the present first embodiment, the following effects can be obtained.

(1a) In the first embodiment, the vehicle control unit 17 determines the notifiable information based on the vehicle traveling situation, vehicle exterior situation, and vehicle interior situation obtained by each recognition unit 21, 23, and 25. Furthermore, the notifiable information is provided to the server application unit 19 and the vehicle application unit 15 (that is, the applications installed in the application units 15 and 19). Then, based on the notifiable information, the server application unit 19 and the vehicle application unit 15 notify the vehicle control unit 17 of the information provided by the application (i.e., application information) to the occupant.

In this way, in this first embodiment, the server application unit 19 and the vehicle application unit 15 notify the occupant of the application information through the vehicle control unit 17 based on the notifiable information, so that the vehicle control unit 17 can appropriately notify the occupant of the application information at the appropriate time. In other words, by using the actuator 11 that can be used for notification, for example, it is possible to take a sufficient amount of time to notify the occupant of necessary application information.

(1b) In the first embodiment, the vehicle control unit 17 can set the notifiable information, such as the notifiable time, the notification type, and the notification mode (i.e., the mode of notification) according to the situation, and provide the information to the application.

The notification mode according to the situation can be set in the application based on the vehicle-related situation and provided to the vehicle control unit 17. For example, when the occupant is busy, the notification mode may be set according to the busy state, such as making the application information compact.

(1c) In the first embodiment, the application can set application information that is the notification target to the occupant based on the vehicle-related situation and the notifiable information.

Thereby, it is possible to provide, to the occupant, the notification of appropriate application information at the appropriate time.

(1d) In the first embodiment, it is determined whether the application is in a state in which it is possible to notify the occupant of application information by the application. Therefore, according to the determination result, when the notification is possible, it is possible to appropriately provide the notification of application information.

Separately from this, the application may determine whether it is appropriate to notify the occupant of the application information. For example, when notification of information necessary for safe driving is currently being provided, it can be determined that it is not appropriate to provide notification of, for example, advertisements.

(1e) In the first embodiment, the vehicle control unit 17 determines whether it is possible to notify the occupant of application information. Therefore, according to the determination result, when the notification is possible, it is possible to appropriately provide the notification of application information.

Separately from this, the vehicle control unit 17 may determine whether it is appropriate to notify the occupant of the application information. For example, when notification of information necessary for safe driving is currently being provided, it can be determined that it is not appropriate to provide notification of, for example, the advertisement. In addition, examples of appropriate states for the notification of the application information to the occupant include a state where, when notifying the occupant of the application information, there is no disruption to the current situation, a state where disadvantageous effects do not occur on the current situation, a state where at least no deterioration is progresses in the current situation, and the like. The states are related to drivability (i.e., a state indicating ease of driving), safety of the vehicle and occupants, and comfort of the occupants.

(1f) In the first embodiment, when the vehicle control unit 17 notifies the occupant of application information, the vehicle control unit 17 transmits the notification to the application. Thereby, the application can grasp that the notification has been provided. Therefore, it is possible to reduce the process such as making the notification request again.

In addition, when the notification of the application information is not provided to the occupant, determination indicating no notification may be transmitted to the application. Thereby, the application can request the application again at a later time.

### 1-6. Correspondence Relationship

Next, the relationship between the first embodiment and the present disclosure will be described.

The information notification system 1 corresponds to the information notification system, the vehicle control unit 17 corresponds to the vehicle control unit, the information decision unit 51 corresponds to the information decision unit, and the information provision unit 53 corresponds to the information provision unit.

### 2. Second Embodiment

A basic configuration of a second embodiment is similar to that of the first embodiment, and hence a difference from the first embodiment will be mainly described below. Note that the same reference numerals as those in the first embodiment indicate the same configuration, and refer to the previous descriptions.

In the second embodiment, the vehicle control unit 17 executes various adjustment processes.

### Embodiment 2a

In this embodiment 2a, when notification requests are made from multiple applications each requesting to notify the occupant of application information, the vehicle control unit 17 adjusts which application information to notify the occupant of. For example, adjustments of the notification target of the application information and the non-notification target of the application information are performed.

For example, in a case where a vehicle is traveling in bad weather and there is a limit to the time during which the notification of application information is possible, when notification of both application information related to the weather and application information related to advertisements has been provided, the application information related to the weather is selected and the notification is provided.

### Embodiment 2b

In this embodiment 2n, when notification requests are made from multiple applications each requesting to notify the occupant of application information, the vehicle control unit 17 adjusts the notification order of each application information to the occupant.

For example, when a notification request is made for application information related to safety and application information for general advertising, the application information related to safety is considered to have a higher priority, so the notification of the application information with the highest priority is provided to the occupants in that order. Thereby, it is possible to promptly notify the occupant of application information that is highly necessary for the occupant.

### Embodiment 2c

In this embodiment 2c, when an application makes the notification request to notify the occupant of application information, the second processing unit 60 of the vehicle control unit 17 adjusts the state when notifying the occupant of the application information to match the actual vehicle-related situation (i.e., vehicle-related situation).

For example, when driving at high speed (i.e., when the driver is busy), the advertisement content may be adjusted to be more compact so as not to place an excessive burden on the driver compared to when driving at low speed, or the notification content that is displayed and provided by audio may be adjusted to a content provided by audio only. Thereby, it is possible to appropriately notify the occupant of app information depending on the actual situation.

Note that adjusting the state when notifying the occupant includes not notifying the occupant (the same applies below).

### 3. Third Embodiment

A basic configuration of a third embodiment is similar to that of the first embodiment, and hence a difference from the first embodiment will be mainly described below. Note that the same reference numerals as those in the first embodiment indicate the same configuration, and refer to the previous descriptions.

The third embodiment provides various examples of cases in which the notification of application information is provided to the occupant.

### Example 3a

In this embodiment 3a, at least one of the notification method and the notification contents when notifying the occupant of the application information is changed depending on the vehicle traveling situation.

Hereinafter, the process procedure in this embodiment 3a will be briefly described.

For example, when the traveling situation recognition unit 21 recognizes the traveling situation of the vehicle, information on the traveling situation and information on the notification mode according to the situation (for example, information on what notification type is possible) are transmitted in advance to an application (i.e., the vehicle application unit 15 and the server application unit 19).

Based on the information transmitted from the traveling information recognition unit 21, the application determines under what state (i.e., the notification method and notification content) it is appropriate to transmit the application information to the vehicle control unit 17. For example, at least one of the notification method or the notification contents when notifying the occupant of the application information is changed depending on the vehicle traveling situation. Then, the notification request is made to the vehicle control unit 17 at an appropriate timing (i.e., a timing when the notification to the occupant is possible), and the application information changed as described above is also transmitted to the vehicle control unit 17.

Then, upon receiving the notification request, the vehicle control unit 17 determines whether it is appropriate to actually provide the application information to the occupant, and when appropriate, provides the application information to the occupant.

In Examples 3b and 3c described later, the types of situations are different from those in Example 3a, but the processing procedures are similar, so that the description of the processing procedures in embodiments 3b and 3c will be omitted.

Examples of changes to the notification method include changing the type of actuator 11 used or the number of actuators 11 (for example, two types: the display device 33 and the speaker 35, or three types: the display device 33, the speaker 35, and the steering wheel 37). For example, in the case of application information with a high notification priority (i.e., urgency), the actuator 11 (for example, speaker 35) that is easy for the occupant to recognize without visual inspection may be used, or a large number of actuators 11 may be used. Note that changing the notification method also includes changing it so that no notification is given (the same applies below).

The vehicle traveling situation may include at least one of a vehicle traveling speed, the vehicle stop situation, or a vehicle traffic congestion situation.

The vehicle traveling speed may be a high speed equal to or greater than a predetermined value, or a constant speed less than a predetermined value. The stopping situation of a vehicle indicates the situations under which the vehicle is stopped, and examples of this stopping situation include a temporary stopping status due to restrictions such as traffic lights or intersections, and a stopping situation that is not due to such restrictions. The traffic congestion situation of a vehicle indicates the traffic congestion situation in the periphery of the vehicle (for example, the subject vehicle), and this traffic congestion situation may include, for example, the traffic congestion situation on the road on which the vehicle is traveling, obtained from the cloud or the like.

Hereinafter, further, a detailed example will be described.

(1) The notification method and notification contents may be changed depending on the traveling speed. For example, the notification method may be changed depending on whether the vehicle speed is high or low. For example, in a case of traveling at high speed, it is considered that the occupant is in the busy state that requires attention to driving, so notification of application information may be stopped. The notification method refers to a method for providing notification of application information, and the notification content refers to the content of the application information that is the notification target (the same applies below).

(2) The notification method and notification contents may be changed depending on a stopping scene (i.e., the manner of the vehicle stop). For example, the notification method may be changed depending on whether the vehicle is stopped while waiting for a traffic light or is otherwise parking or stopping (i.e., voluntary parking or stopping that is not subject to regulations). For example, when waiting at a traffic light, notification of application information may be stopped.

(3) The notification method and content may be changed depending on the traffic congestion situation. For example, the notification method may be changed depending on whether the vehicle is in the traffic congestion or traveling at a constant speed. For example, notification of application information may be stopped during the traffic congestion.

### Example 3b

In this embodiment 3b, at least one of the notification method and the notification contents when notifying the occupant of information is changed depending on the situation outside the vehicle. The notification method and notification contents are the same as those in the above-described embodiment 3a.

As the vehicle exterior situation, at least one of the weather situation in the periphery of the vehicle or the situation of the road on which the vehicle is traveling can be adopted.

The weather situations include rain, cloudy and dark weather, and sunny weather. The situations of the road on which the vehicle is traveling include the type of road on which the vehicle is traveling (for example, expressway or general road), the number of lanes, whether travel is restricted due to road construction, the degree of road congestion, such as the number of other vehicles in the periphery of the subject vehicle and the distance between the other vehicles, and the like. The road situations indicate the road type, the road situation, the situation of objects on the road, and may include the traffic congestion situation of the road.

Hereinafter, further, a detailed example will be described.

(1) The notification method and content may be changed depending on the weather. For example, the notification method may be changed depending on whether the weather is bad, such as rain or snow, or good weather, such as sunny or cloudy, compared to the bad weather. For example, when the weather is bad, it is considered that the occupant is in the busy state that requires attention while driving, so notification of application information may be stopped.

(2) The notification method and notification contents may be changed depending on the situations of the road on which the vehicle is traveling. For example, the notification method may be changed depending on whether the road is an expressway or an ordinary road. For example, in the case of the expressway, it is considered that the occupant is busy, so notification of application information may be stopped. Also, for general roads, the notification method may be changed depending on whether the road is a normal city road or a narrow road that is narrower than the city road. For example, in the case of the narrow road, it is considered that the occupant is busy, so notification of application information may be stopped.

### Example 3c

In this embodiment 3c, at least one of the notification method or the notification contents when notifying the occupant of information is changed depending on the vehicle interior situation. The notification method and notification contents are the same as those in the above-described embodiment 3a.

The vehicle interior situation may be at least one of the role of the occupant, the moving state of the occupant, the characteristics of the occupant, or the riding time of the occupant.

The role of the occupant indicates a functional distinction between the occupants, and examples of the role of the occupant include whether the occupant is a driver or another occupant.

Examples of the movement state of an occupant include the position of the occupant inside a bus or inside e-Palette with the automated driving and changes therein (for example, the position before movement and the position after movement). The position of the occupant can be determined, for example, by well-known image recognition using camera images or by using position information from a mobile device such as a smart phone.

The characteristics of the occupant indicate the characteristics of the occupant himself/herself (for example, external characteristics and psychological characteristics), and examples of the characteristics of the occupant include whether the occupant is an adult or a child. Furthermore, occupant's hobbies, thoughts, physical situations, and the like may be understood as occupant's characteristics. In addition, the characteristics of the occupant can be set and stored in advance on the vehicle side or on the cloud side. It is also possible to obtain the information from a portable terminal carried by the occupant.

The occupant riding time may be the time elapsed since the occupant got into the vehicle. For example, the driver's driving time can be used. For example, this can be determined by well-known image recognition using camera images.

Hereinafter, further, a detailed example will be described.

(1) The notification method and content may be changed depending on the role of the occupant. For example, the notification method may be changed depending on whether the occupant is the driver, the occupant is an occupant on the passenger seat, or another occupant. For example, when the occupant is the driver, it is considered that the occupant is busy, so for example, the notification of advertisements may be stopped, and advertisements may be notified to persons other than the driver.

Also, the notification method may be changed depending on whether the occupant is, for example, the bus driver or a bus occupant (i.e., a passenger). For example, when the occupant is a bus driver, the occupant is considered to be busy, so advertisement notification may be stopped, and notification of advertisements may be provided to the occupant other than the driver.

Furthermore, for example, when the vehicle is the e-Palette with the automated driving, the notification method may be changed depending on whether the person is a tour conductor or the occupant. For example, when the occupant is a tour conductor, it is considered that the crew member is busy, so for example, advertisement notification may be stopped, and advertisements may be notified to those other than the tour conductor.

(2) The notification method and the notification contents may be changed depending on the movement state of the occupant (for example, the position of the occupant). For example, when the occupant moves to another location inside the vehicle such as the e-Palette, the actuator 11 at the moved location may be used to notify the application information.

(3) The notification method and the notification contents may be changed depending on the characteristics of the occupant. For example, the notification method and content can be changed depending on whether the occupant is an adult or a child, or depending on the occupant's hobbies, thoughts, physical situation, and the like. For example, when the occupant is an adult, advertisements suitable for adults can be displayed, whereas when the occupant is a child, advertisements suitable for children can be displayed. Furthermore, even when the occupant is changed, application information corresponding to the characteristics of the occupant can be provided.

(4) The notification method and content may be changed depending on the occupant riding time. For example, when the occupant is on board for a long time, there is a possibility that they may become tired or bored, so when the content is important from a safety perspective, it is possible to notify the application information by increasing the intensity of the notification (for example, by making the displayed light brighter or the sound louder) compared to when the ride time is short.

### 4. Other Embodiments

While the embodiments of the present disclosure have been described above, the present disclosure is not limited to the above embodiment and can be variously modified.

(4a) The application may be placed (i.e., installed) in at least one of the server and the vehicle, and the number of installed applications may be one or more.

(4b) The information notification system, vehicle control device, program, and information notification method described in the present disclosure can be applied to manual driving and automated driving. In the case of automated driving, for example, it can be applied to levels 2 to 5 according to the US SAE (Society of Automotive Engineers) standards.

(4c) The information notification system, vehicle control device, and information notification method described in the present disclosure may be implemented by a dedicated computer provided by configuring a processor and memory programmed to perform one or more functions embodied in a computer program.

Alternatively, the information notification system, the vehicle control device, and the information notification method described in the present disclosure may be implemented by the dedicated computer provided by configuring a processor with one or more dedicated hardware logic circuits.

Alternatively, the information notification system, the vehicle control device, and the information notification method described in the present disclosure may be implemented by one or more dedicated computers configured by a combination of a processor and a memory programmed to execute one or more functions and a processor configured by one or more hardware logic circuits.

The computer program may be stored in a computer-readable non-transitory tangible storage medium as instructions to be executed by a computer. The technique for implementing the functions of the respective units included in the information notification system, the vehicle control device, and the information notification method does not necessarily need to include software, and all of the functions may be implemented with the use of one or multiple hardware.

(4d) In addition to the above-described information notification system, vehicle control device, and information notification method, the present disclosure can also be implemented in various forms, such as a system, device, and method that have, as components, the information notification system, vehicle control device, and information notification method, a program for causing a computer that implements the information notification system, vehicle control device, and information notification method to function, a non-transitory tangible storage medium such as a semiconductor memory on which this program is stored, and a processing method for the information notification system and vehicle control device.

(4e) Multiple functions of one element in the above embodiment may be implemented by multiple elements, or one function of one element may be implemented by multiple elements. Further, multiple functions of multiple elements may be implemented by one element, or one function implemented by multiple elements may be implemented by one element. A part of the configuration of the above embodiments may be omitted as appropriate. At least a part of the configuration of the above embodiment may be added to or replaced with the configuration of another embodiment.

What is claimed is:

1. An information notification system in which one or more applications are provided in at least one of a vehicle or a cloud, and notification of application information that is information provided by the one or more applications is provided from the vehicle to an occupant, wherein
the vehicle includes: as a vehicle control unit configured to control an operation of the vehicle,
an information decision unit configured to determine notifiable information indicating a situation required for notifying the occupant of the application information based on a vehicle-related situation indicating at least one of
a vehicle traveling situation indicating a traveling situation of the vehicle,
a vehicle exterior situation indicating a situation in a periphery of the vehicle, or
a vehicle interior situation indicating a situation inside the vehicle; and
an information provision unit configured to provide the notifiable information determined by the information decision unit to the application, and
the application is configured to request the vehicle control unit to notify the occupant of the application information based on the notifiable information provided by the information provision unit.

2. The information notification system according to claim 1, wherein
the vehicle control unit is configured to set at least one of a notifiable time, a notification type, or a notification mode according to a situation as the notifiable information and provide the at least one to the application.

3. The information notification system according to claim 1, wherein
the vehicle control unit is configured to determine whether notification of the application information from the application to the occupant is possible or appropriate when the application requests the vehicle control unit to notify the occupant of the application information after the information provision unit provides the notifiable information to the application.

4. The information notification system according to claim 3, wherein
the vehicle control unit is configured to adjust a state in which the notification of the application information is provided to the occupant in response to a request, depending on the vehicle-related situation.

5. The information notification system according to claim 1, wherein
the application is configured to set a notification mode according to the situation based on the vehicle-related situation and provide the notification mode to the vehicle control unit.

6. The information notification system according to claim 2, wherein
at least one of a notification method or a notification content at a time of the notification of the application information to the occupant is changed according to the vehicle traveling situation.

7. The information notification system according to claim 6, wherein
the vehicle traveling situation is at least one of a traveling speed of the vehicle, a stopping situation of the vehicle, or a traffic congestion situation of the vehicle.

8. The information notification system according to claim 2, wherein
at least one of a notification method or a notification content at a time of the notification of the application information to the occupant is changed according to the vehicle exterior situation.

9. The information notification system according to claim 8, wherein
the vehicle exterior situation is at least one of a weather situation in the periphery of the vehicle or a situation of a road on which the vehicle is traveling.

10. The information notification system according to claim 2, wherein
at least one of a notification method or a notification content at a time of the notification of the application information to the occupant is changed according to the vehicle interior situation.

11. The information notification system according to claim 10, wherein
the vehicle interior situation is at least one of a role of the occupant, a movement state of the occupant, a characteristic of the occupant, or a riding time of the occupant.

12. The information notification system according to claim 1, wherein
in a case where the application includes a plurality of applications, when the plurality of applications provide a notification request for requesting the notification of each application information to the occupant,
the vehicle control unit adjusts
whether to provide the notification of at least one of the application information to the occupant or
an order of the notification of each application information to the occupant.

13. The information notification system according to claim 1, wherein
when the application provides a notification request for requesting the notification of the application to the occupant, the vehicle control unit adjusts a state for the notification of the application information to the occupant so as to match the vehicle-related situation that is in an actual state.

14. The information notification system according to claim 1, wherein
the application is configured to
determine whether the notification of the application information to the occupant is possible or appropriate, and
when determining that the notification is possible or appropriate, request the vehicle control unit to notify the occupant of the application information.

15. The information notification system according to claim 1, wherein
the vehicle control unit is configured to
determine whether the notification of the application information to the occupant is possible or appropriate, and
when determining that the notification is possible or appropriate, request the notification of the application information to the occupant.

16. The information notification system according to claim 1, wherein
the application is configured to set the application information for the notification to the occupant based on the vehicle-related situation and the notifiable information.

17. The information notification system according to claim 1, wherein
the vehicle control unit is configured to notify the occupant of the application information.

18. The information notification system according to claim 17, wherein
when the vehicle control unit notifies or does not notify the occupant of the application information, the vehicle control unit is configured to transmit a notification result indicating presence or absence of the notification to the application.

19. A vehicle control device for notifying an occupant of application information that is information provided from a vehicle to the occupant based on a request from one or more applications provided in at least one of the vehicle or a cloud, the vehicle control device comprising:
an information decision unit configured to determine notifiable information indicating a situation required for notifying the occupant of the application information based on a vehicle-related situation indicating at least one of
a vehicle traveling situation indicating a traveling situation of the vehicle,
a vehicle exterior situation indicating a situation in a periphery of the vehicle, or
a vehicle interior situation indicating a situation inside the vehicle;
an information provision unit configured to provide the notifiable information determined by the information decision unit to the application; and
an occupant provision unit configured to instruct a notification device to provide the application information to the occupant when the application requests that notification of the application information is provided to the occupant based on the notifiable information provided by the information provision unit.

20. A non-transitory computer-readable storage medium storing a program executed by an information notification system in which one or more applications are provided in at least one of a vehicle or a cloud, and notification of application information that is information provided by the one or more applications is provided from the vehicle to an occupant, the program being executed to:
determine notifiable information indicating a situation required for notifying the occupant of the application information based on a vehicle-related situation indicating at least one of
a vehicle traveling situation indicating a traveling situation of the vehicle,
a vehicle exterior situation indicating a situation in a periphery of the vehicle, or
a vehicle interior situation indicating a situation inside the vehicle;
provide the determined notifiable information to the application; and
cause the application to request a vehicle control unit that controls an operation of the vehicle to notify the occupant of the application information based on the provided notifiable information.

21. An information notification method in which one or more applications are provided in at least one of a vehicle or a cloud, and notification of application information that is information provided by the one or more applications is provided from the vehicle to an occupant, the method comprising:
determining notifiable information indicating a situation required for notifying the occupant of the application information based on a vehicle-related situation indicating at least one of
a vehicle traveling situation indicating a traveling situation of the vehicle,
a vehicle exterior situation indicating a situation in a periphery of the vehicle, or
a vehicle interior situation indicating a situation inside the vehicle;
providing the determined notifiable information to the application; and
causing the application to request a vehicle control unit that controls an operation of the vehicle to notify the occupant of the application information based on the provided notifiable information.
